(19) United States
(12) Patent Application Publication
(10) Pub. No.: US 2007/0229431 A1
(43) Pub. Date: Oct. 4, 2007

(54) DISPLAY PANEL AND METHOD OF DRIVING DISPLAY PANEL USING INVERSION DRIVING METHOD

(76) Inventors: Won-sik Kang, Seoul (KR); Jae-hyuck Woo, Osan-si (KR)

Correspondence Address: F. CHAU & ASSOCIATES, LLC, 130 WOODBURY ROAD, WOODBURY, NY, 11797, US

(21) Appl. No.: 11/691,776

(22) Filed: Mar. 27, 2007

(30) Foreign Application Priority Data
Apr. 4, 2006 (KR) 10-2006-0030495

(51) Int. Cl. G09G 3/36

(52) U.S. Cl. 345/96

(57) ABSTRACT

A method of driving a display panel that comprises a plurality of source lines, a plurality of gate lines, a plurality of cell capacitors each of which includes a pixel electrode and a common electrode, and a plurality of cell transistors that transmit a data voltage applied to the source lines to the pixel electrodes in response to a gate driving voltage applied to the gate lines. A common voltage, which is toggled from a first reference voltage to a second reference voltage, or vice versa, is applied to the common electrode. When the data voltage is applied to an odd-numbered source line, the neighboring even-numbered source line enters a floating state. When the data voltage is applied to an even-numbered source line, the neighboring odd-numbered source line enters a floating state.

### CROSS-REFERENCE TO RELATED PATENT APPLICATION

This application claims priority to Korean Patent Application No. 10-2006-0030495, filed on Apr. 4, 2006, the disclosure of which is herein incorporated by reference in its entirety.

### BACKGROUND OF THE INVENTION

1. Technical Field

The present disclosure relates to a display panel and a method of driving a display panel and, more particularly, to a display panel and a method of driving a display panel using an inversion driving method.

2. Discussion of Related Art

Liquid crystal display (LCD) panels are widely used in various fields. For example, thin film transistor LCDs (TFT-LCD) are commonly used for LCD televisions, laptop computers, desk top computers, and mobile terminals such as a cellular phone or PDA (Personal Digital Assistant).

FIG. 1 is a circuit diagram of a conventional TFT-LCD panel. Referring to FIG. 1, the TFT-LCD panel includes a plurality of source lines S1 through S4, a plurality of gate lines G1 through G4, a plurality of cell transistors TFT and a plurality of cell capacitors CLC. Each of the cell capacitors CLC is a capacitor formed by a common electrode and a pixel electrode with a liquid crystal interposed therebetween. A common voltage Vcom is applied to the common electrode of every cell capacitor CLC.

An LCD panel includes a plurality of pixels arranged in matrix form. A pixel is defined at the intersection of a gate line and a source line. Each pixel may include a cell capacitor CLC and a cell transistor TFT. When a gate driving voltage is applied to the gate and the cell transistor TFT turns on, a data voltage applied to the source line is transmitted to the pixel electrode of the cell capacitor CLC. The liquid crystal alignment in the cell capacitor CLC, which is proportional to the voltage difference between a data voltage applied to the pixel electrode and a common voltage applied to the common electrode, determines transmitivity of the LCD. Thus, the resultant luminance of the LCD panel corresponds to the magnitude of the data voltage.

To prevent deterioration of the liquid crystal, which can result from application of a direct current (DC) component, LCD panels have been driven using an inversion driving method. Using an inversion method, the polarity of the voltage applied to the liquid crystal is inverted every predetermined period. Such drive methods include frame inversion, line inversion, column inversion, and dot inversion, as shown in FIG. 2.

FIG. 2 illustrates various conventional inversion driving methods for LCD devices. Referring to FIG. 2, G1 through G4 correspond to the gate lines G1 through G4 of FIG. 1, and S1 through S4 correspond to the source lines S1 through S4 of FIG. 1. All of the diagrams of FIG. 2 are formed by blocks of 4×4 pixels.

The first row of diagrams, in FIG. 2, represents a frame inversion method, the second row of diagrams illustrates a line inversion method, the third row of diagrams shows a column inversion method and the fourth row of diagrams depicts a dot inversion method. Besides these types of methods, a 2-dot inversion method has been used.

In frame inversion, 16 pixels in a frame are simultaneously inverted into the same polarity. In comparison, in line inversion or column inversion, four pixels included in each group are simultaneously inverted into the same polarity. In dot inversion, each pixel is simultaneously changed into the opposite polarity.

The frame inversion driving method having the largest size of a pixel group to be simultaneously inverted into the same polarity has low current consumption, but may not display high-quality images. In contrast, the dot inversion driving method having the smallest size of a pixel group to be simultaneously inverted into the same polarity consumes a large amount of current, but can display high-quality images. As the size of display panels is increased, column inversion and dot inversion driving methods have been used, for example, in display devices having big screens, to display high-quality images.

### SUMMARY OF THE INVENTION

According to an exemplary embodiment of the present invention, a method of driving a display panel that comprises a plurality of source lines, a plurality of gate lines, a plurality of cell capacitors each of which includes a pixel electrode and a common electrode, and a plurality of cell transistors each of which transmits a data voltage applied to the source line to the pixel electrode in response to a gate driving voltage applied to the gate line, comprises applying a common voltage, which is toggled from a first reference voltage to a second reference voltage, or vice versa, at each boundary between a first half frame and a second half frame, to the common electrode, applying data voltage at a positive or a negative potential with respect to the common voltage to odd-numbered source lines and operating even-numbered source lines to enter a floating state in the first half frame, and applying data voltage at a negative or a positive potential with respect to the common voltage to the even-numbered source lines and operating the odd-numbered source lines to enter a floating state in the second half frame.

According to an exemplary embodiment of the present invention, a method of driving a display panel comprises when a half frame is divided into gate line regions, applying a common voltage to a common electrode, wherein the common voltage is toggled from a first reference voltage to a second reference voltage, or vice versa, every time a gate line region is changed to the next gate line region, in a first half frame, applying the data voltages at a positive or a negative potential with respect to the common voltage to odd-numbered source lines and operating even-numbered source lines to enter a floating state, in a second half frame, operating the odd-numbered source lines to enter a floating state and applying the data voltages at a negative or a positive potential with respect to the common voltage to the even-numbered source lines.

According to an exemplary embodiment of the present invention, a method of driving a display panel comprises, when a frame is divided into gate line regions and each gate line region is divided into a first section and a second section, applying a common voltage to the common electrode, wherein the common voltage is toggled from a first reference voltage to a second reference voltage, or vice versa, at every boundary between the first section and the second section, in the first section, applying the data voltage at a positive or a negative potential with respect to the common voltage to odd-numbered source lines and operating even-numbered source lines to enter a floating state, and in the second section, operating the odd-numbered source lines to enter a floating state and applying the data voltage at a negative or a positive potential with respect to the common voltage to the even-numbered source lines.

According to an exemplary embodiment of the present invention, a display panel comprises a plurality of source lines, a plurality of cell capacitors each of which includes a pixel electrode and a common electrode, a plurality of cell transistors each of which transmits or blocks a data voltage applied to the source line to the pixel electrode, first gate lines to which gate driving voltages are applied, the gate driving voltages controlling turning on and turning off of the cell transistors connected to odd-numbered source lines, and second gate lines to which gate driving voltages are applied, the gate driving voltages controlling turning on and turning off of the cell transistors connected to even-numbered source lines, wherein the display panel is driven using a column inversion or dot inversion driving method.

When the display panel includes M source lines, the data voltages may be applied to the M source lines by M/2 source amplifiers, where M is a natural number. Each of the M/2 source amplifiers may drive an odd-numbered source line and a neighboring even-numbered source line.

Each of the M/2 source amplifiers may operate the neighboring even-numbered source line to enter a floating state when the data voltage is applied to the odd-numbered source line, and operate the odd-numbered source line to enter a floating state when the data voltage is applied to the neighboring even-numbered source line.

### BRIEF DESCRIPTION OF THE DRAWINGS

The present invention will become readily apparent to those of ordinary skill in the art when descriptions of exemplary embodiments thereof are read with reference to the accompanying drawings.

FIG. 1 is a circuit diagram of a conventional thin film transistor liquid crystal display (TFT-LCD) panel.

FIG. 2 illustrates various conventional inversion driving methods for LCD devices.

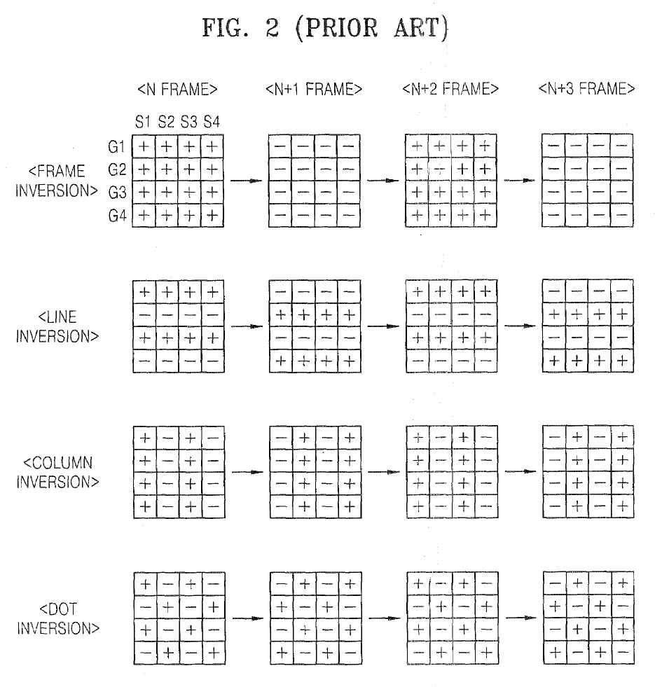

FIG. 3A is a timing diagram for illustrating a column inversion method.

FIG. 3B is a timing diagram for illustrating a gate driving voltage applied to gate lines in the column inversion method of FIG. 3A.

FIG. 3C is a timing diagram for illustrating a column inversion method according to an exemplary embodiment of the present invention.

FIG. 3D is a timing diagram for illustrating a gate driving voltage applied to a gate line according to the column inversion method of FIG. 3C.

FIG. 3E illustrates configurations of a screen according to the column inversion method of FIG. 3C.

FIG. 4A is a timing diagram for illustrating a dot inversion method.

FIG. 4B is a timing diagram for illustrating a dot inversion method according to an exemplary embodiment of the present invention.

FIG. 4C illustrates configurations of a screen according to the dot inversion method of FIG. 4B.

FIG. 5A is a timing diagram for illustrating a dot inversion method according to an exemplary embodiment of the present invention.

FIG. 5B illustrates configurations of a screen according to the dot inversion method of FIG. 5A.

FIG. 6 is a circuit diagram of a display panel driven according to the driving method of FIG. 3C, FIG. 4B, or FIG. 5A.

### DESCRIPTION OF EXEMPLARY EMBODIMENTS

Hereinafter, exemplary embodiments of the present invention will be described in detail with reference to the accompanying drawings. Like reference numerals refer to similar or identical elements throughout the description of the figures.

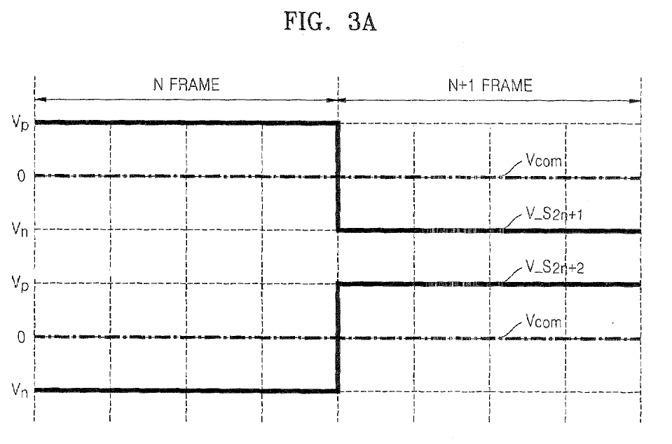

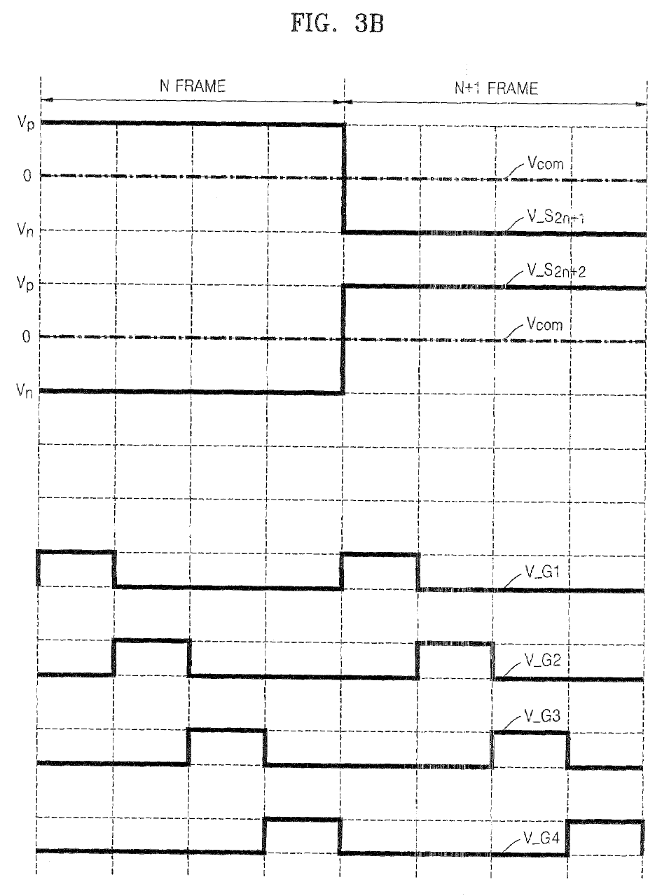

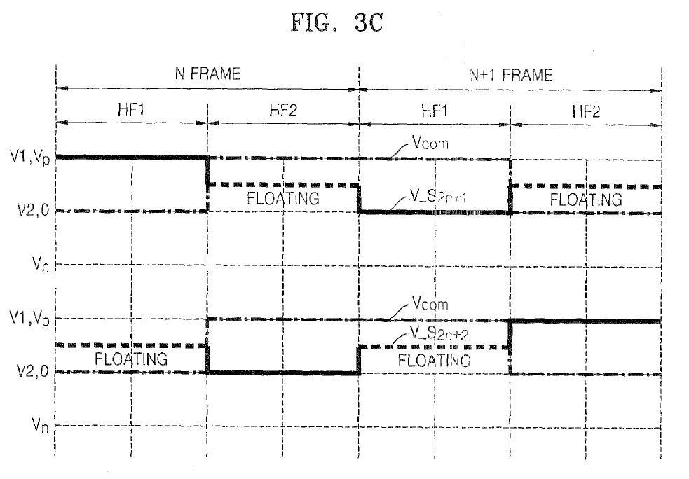

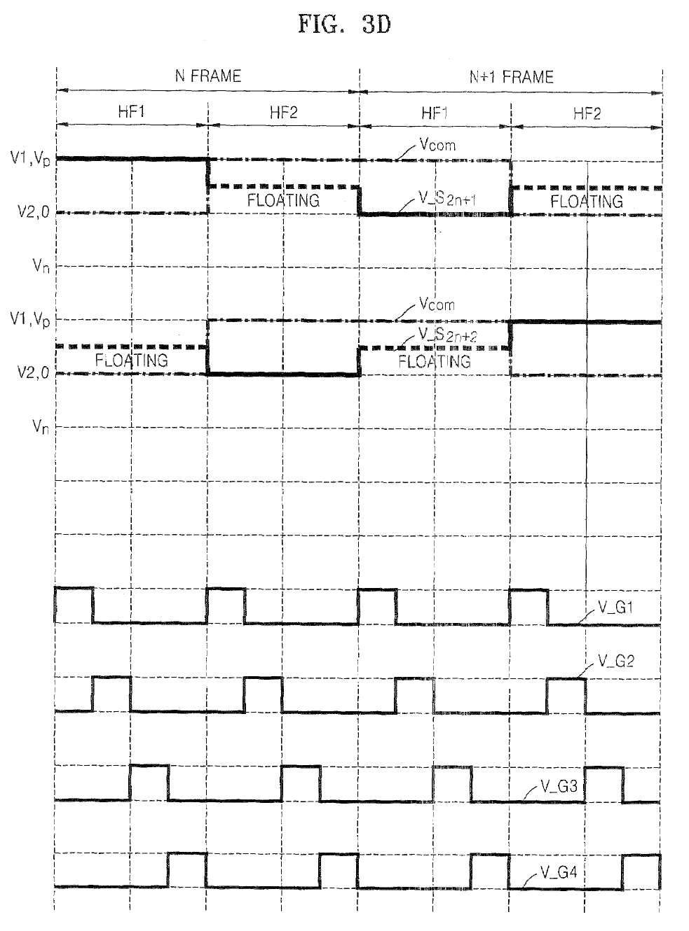

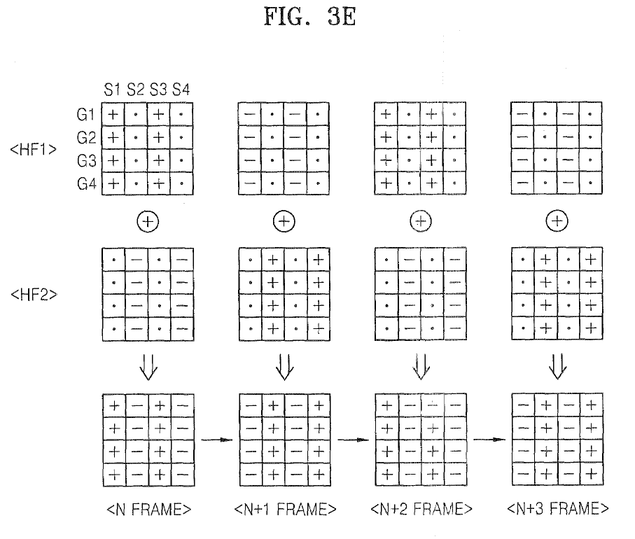

FIG. 3A is a timing diagram for illustrating a column inversion method. FIG. 3B is a timing diagram for illustrating a gate driving voltage applied to gate lines in the column inversion method of FIG. 3A.

FIG. 3A illustrates a common voltage Vcom, which is applied to a common electrode of a cell capacitor CLC in an N frame and an N+1 frame, and data voltages V_S2n+1 and V_S2n+2, which are applied to a pixel electrode of the cell capacitor CLC in those frames. A source amplifier (not shown) that drives source lines of the display panel applies data voltages V_S2n+1 and V_S2n+2, which correspond to image data input from the outside, to the source lines, and the data voltages V_S2n+1 and V_S2n+2 are transmitted to the pixel electrode of the cell capacitor CLC, passing through a cell transistor TFT.

In the interests of simplicity, the data voltages V_S2n+1 and V_S2n+2 are illustrated as having fixed voltage levels Vp and Vn. Since a grayscale level of the data voltage is determined to correspond to the image data input from an external device, the actual data voltage has various grayscale levels. In FIG. 3A, data voltages of positive potential Vp with respect to the common voltage Vcom of zero potential and data voltages of negative potential Vn with respect to the common voltage Vcom are illustrated.

The data voltage V_S2n+1 is applied to an odd-numbered source line, and the data voltage V_S2n+2 is applied to an even-numbered source line. As shown in FIG. 3A, the polarities of the data voltages V_S2n+1 and V_S2n+2, which are applied to the source lines, are changed in each frame according to the column inversion method. In an exemplary embodiment of the present invention, the data voltage V_S2n+1 applied to the odd-numbered source line has the opposite polarity to that of the data voltage V_S2n+2 applied to the even-numbered source line.

FIG. 3B illustrates data voltages V_S2n+1 and V_S2n+2, a common voltage Vcom and gate driving voltages V_G1, V_G2, V_G3, and V_G4, which are applied to a display panel including only four gate lines for ease of description.

In an N frame, the potential of the data voltage V_S2n+1 applied to the odd-numbered source line is a positive potential Vp with respect to the common voltage Vcom, and the potential of the data voltage V_S2n+2 applied to the even-numbered source line is a negative potential Vn with respect to the common voltage. In comparison, in an N+1 frame, the potential of the data voltage V_S2n+1 applied to the odd-numbered source line is a negative potential Vn, and the potential of the data voltage V_S2n+2 applied to the even-numbered source line is a positive potential Vp.

As shown in FIG. 3B, the gate driving voltages V_G1, V_G2, V_G3, and V_G4 are applied to the gate lines G1 through G4 such that the same cell transistor TFT is turned on in each frame.

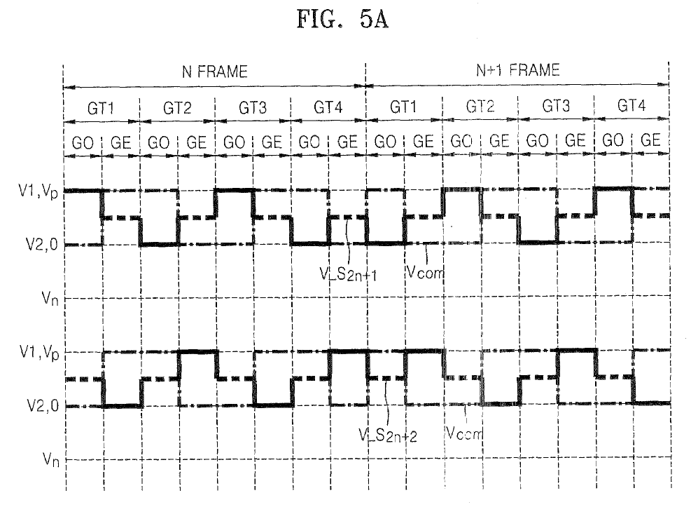

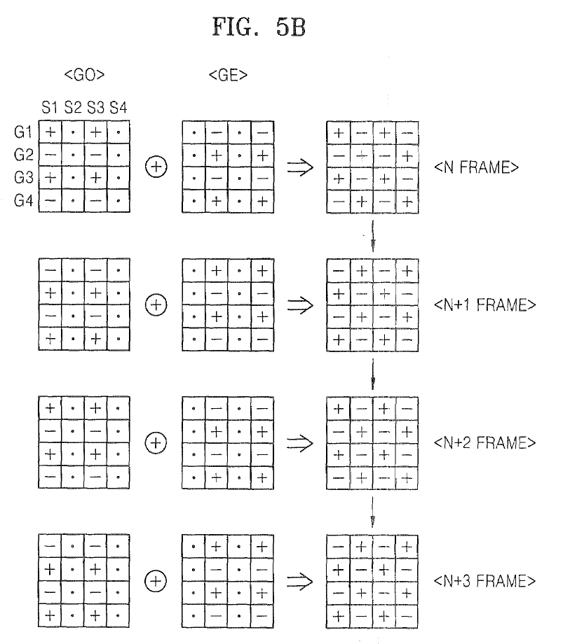

FIG. 3C is a timing diagram for illustrating a column inversion method according to an exemplary embodiment of the present invention. FIG. 3D is a timing diagram for illustrating a gate driving voltage applied to a gate line according to the column inversion method of FIG. 5C.

FIG. 3C illustrates a common voltage Vcom applied to a common electrode of a cell capacitor CLC in an N frame and an N+1 frame, and data voltages V_S2n+1 and V_S2n+2 applied to a pixel electrode of the cell capacitor CLC in each frame.

In a column inversion method according to an exemplary embodiment of the present invention, the common voltage Vcom is toggled from a first reference voltage V1 to a second reference voltage V2 or from the second reference voltage V2 to the first reference voltage V1 at every boundary between a first half frame HF1 and a second half frame HF2. However, the common voltage Vcom is not toggled when the frame is changed, for example, such as when the frame is changed from the N frame to the N+1 frame.

The common voltage Vcom in FIG. 3C is toggled from the first reference voltage V1 to the second reference voltage V2, or vice versa, at a specific point in the frame, unlike in FIG. 3A in which the common voltage Vcom remains at zero. In FIG. 3C, the first reference voltage V1 is at a high logic level, and the second reference voltage V2 is at a low logic level.

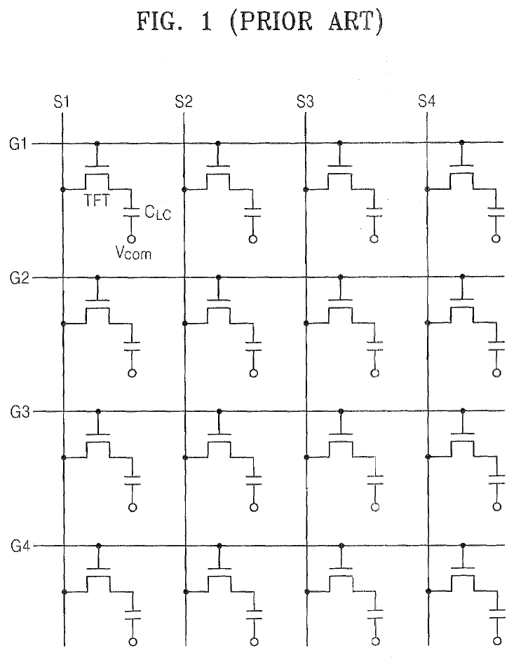

In the first half frame HF1, the data voltages V_S2n+1 of a positive potential or a negative potential with respect to the common voltage Vcom is applied to the odd-numbered source lines, for example, the source lines S1 and S3 of FIG. 1. Meanwhile, the even-numbered source lines, for example, the source lines S2 and S4 in FIG. 1, enter a floating state.

In the second half frame HF2, the odd-numbered source lines enter a floating state, and the data voltages V_S2n+2 of a positive potential or a negative potential with respect to the common voltage Vcom are applied to the even-numbered source lines.

In a column inversion method according to an exemplary embodiment of the present invention, when the data voltage V_S2n+1 is applied to one of the odd-numbered source lines, the neighboring even-numbered source line enters a floating state. On the other hand, when the data voltage V_S2n+2 is applied to one of the even-numbered source lines, the neighboring odd-numbered source line enters a floating state.

Since currents do not flow into the source lines in a floating state, current consumption can be reduced. In an exemplary embodiment of the present invention, when the data voltage is applied to the source line in a half frame of one frame and the source line enters a floating state in the last half frame, the current consumption can be reduced in comparison to when the data voltage is applied to the source line in the whole frame.

Referring to FIG. 3C, in the first half frame HF1 of the N frame, the potential of the common voltage Vcom is the same as that of the second reference voltage V2, the data voltages V_S2n+1 at a positive potential with respect to the common voltage are applied to the odd-numbered source lines, and even-numbered source lines enter a floating state.

In the second half frame HF2 of the N frame, the potential of the common voltage Vcom may be the same as that of the first reference voltage V1. The odd-numbered source lines enter a floating state, and the data voltages V_S2n+2 at a negative potential with respect to the common voltage Vcom are applied to the even-numbered source lines.

In the first half frame HF1 of the N+1 frame, the potential of the common voltage Vcom may be the same as that of the first reference voltage V1. The data voltages V_S2n+1 at a negative potential with respect to the common voltage Vcom are applied to the odd-numbered source lines, and the even-numbered source lines enter a floating state.

In the second half frame HF2 of the N+1 frame, the potential of the common voltage Vcom may be the same as that of the second reference voltage V2. The odd-numbered source lines enter a floating state, and the data voltages V_S2n+2 at a positive potential with respect to the common voltage Vcom are applied to the even-numbered source lines.

An element is needed to apply the data voltages at a Vn potential in the column inversion method illustrated in FIG. 3A, whereas no element is required to apply the data voltages at a Vn potential in the column inversion method according to an exemplary embodiment of the present invention described in connection with FIG. 3C, and the chip size of a driving device can be reduced.

FIG. 3D illustrates data voltages V_S2n+1 and V_S2n+2, a common voltage Vcom and gate driving voltages V_G1, V_G2, V_G3, and V_G4, which are applied to a display panel including only four gate lines for ease of description.

The gate driving voltages V_G1, V_G2, V_G3, and V_G4 illustrated in FIG. 3B turn on the same transistor once in each frame. The gate driving voltages V_G1, V_G2, V_G3, and V_G4 illustrated in FIG. 3D turn on the same transistor twice in each frame. Thus, the gate driving voltages V_G1, V_G2, V_G3, and V_G4 illustrated in FIG. 3D have to drive the gate lines twice as fast as the gate driving voltages V_G1, V_G2, V_G3, and V_G4.

FIG. 3E illustrates configurations of a screen according to the column inversion method of FIG. 3C.

In the first half frame HF1 of the N frame the data voltages of a positive potential with respect to the common voltage Vcom are applied to the odd-numbered source lines S1 and S3, and the even-numbered source lines are in a floating state (denoted by “•”). In the second half frame HF2 of the N frame the odd-numbered source lines are in a floating state, and the data voltages of a negative potential with respect to the common voltage Vcom are applied to the even-numbered source lines S2 and S4. When all of the first and second half frames HF1 and HF2 in the N frame are combined, the data voltages at a positive potential are applied to the odd-numbered source lines S1 and S3 and the data voltages at a negative potential are applied to the even-numbered source lines S2 and S4.

In a similar manner, the data voltages may be applied to the source lines in an N+1 frame, an N+2 frame, and an N+3 frame, A column inversion method according to an exemplary embodiment of the present invention is applied to the N through N+3 frame.

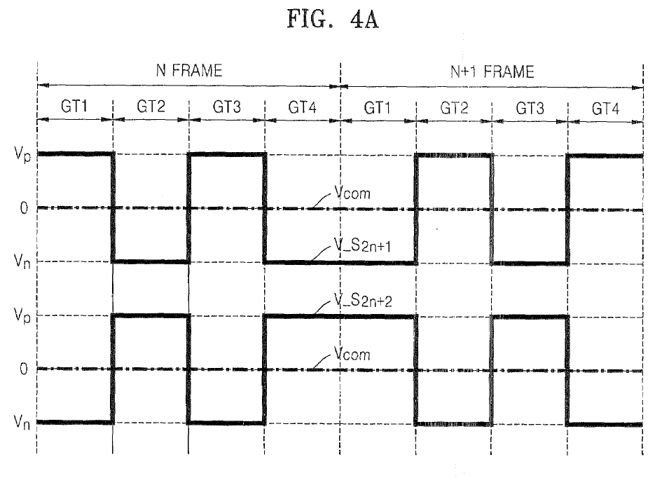

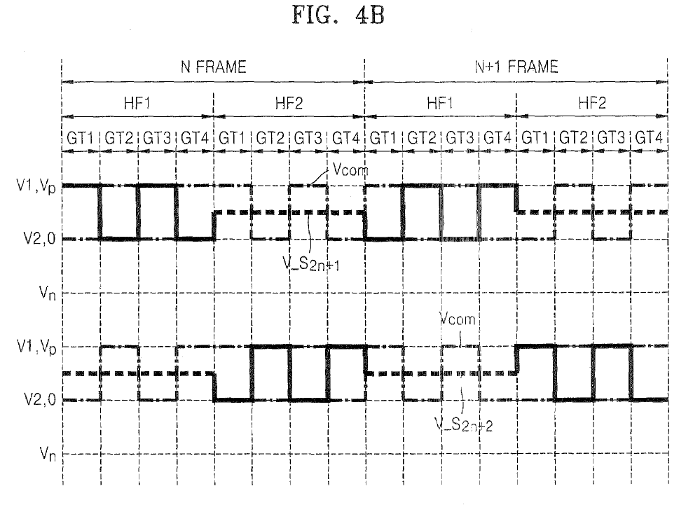

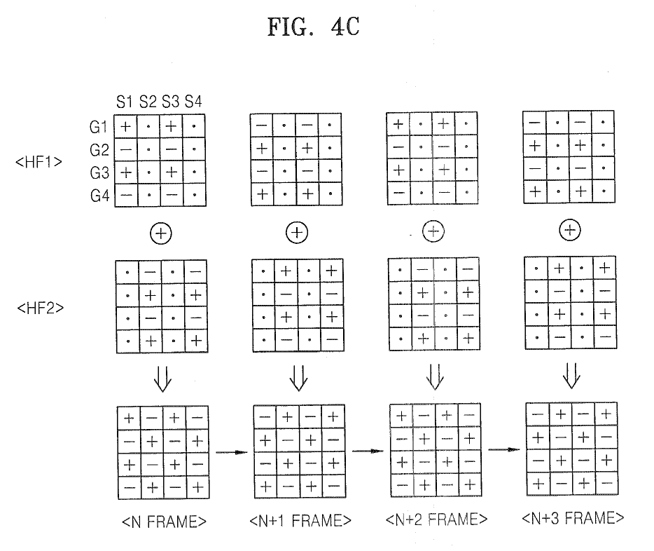

FIG. 4A is a timing diagram for illustrating a dot inversion method.

FIG. 4A illustrates a common voltage Vcom and data voltages V_S2n+1 and V_S2n+2. The common voltage Vcom is applied to the common electrode and the data voltages V_S2n+1 and V_S2n+2 are applied to the pixel electrodes of the cell capacitor CLC in an N+1 frame.

When a frame is divided into gate line regions GT1, GT2, GT3, and GT4, the polarities of the data voltages V_S2n+1 and V_S2n+2 applied to the source lines are changed at each gate line region GT1, GT2, GT3, and GT4. However, when the frame is changed, for example, the frame is shifted from the N frame to the N+1 frame, the polarities of the data voltages V_S2n+1 and V_S2n+2 are not changed. The polarity of the data voltages V_S2n+1 applied to the odd-numbered source lines is opposite to that of the data voltages V_S2n+2 applied to the even-numbered source lines.

As shown in FIG. 4A, the common voltage Vcom applied to the common electrode remains at zero in the whole frame.

According to the dot inversion method of FIG. 4A, the gate driving voltage applied to each gate line turns on the same transistor TFT once in each frame.

FIG. 4B is a timing diagram for illustrating a dot inversion method according to an exemplary embodiment of the present invention. In FIG. 4B, Vcom denotes the common voltage, V_S2n+1 indicates the data voltages applied to the odd-numbered source lines and V_S2n+2 indicates the data voltages applied to the even-numbered source lines. As shown in FIG. 4B, one frame can be divided into a first half frame HF1 and a second half frame HF2, and each half frame can be divided into gate line regions GT1, GT2, GT3, and GT4. For example, in a case when a display panel includes k gate lines G1, G2, G3, through to Gk, each half frame may be divided into k gate line regions GT1, GT2, GT3, through to GTk.

The common voltage Vcom is toggled from a first reference voltage V1 to a second reference voltage V2, or vice versa, each time the gate line region is changed. The common voltage Vcom is toggled from the first reference voltage V1 to the second reference voltage V2, or vice versa, when the frame is changed. However, the common voltage Vcom is not changed when the first half frame HF1 is shifted to the second half frame HF2.

In the first half frame HF1 the data voltages V_S2n+1 of a positive potential or a negative potential with respect to the common voltage Vcom are applied to the odd-numbered source lines, for example, S1 and S3 in FIG. 1. Meanwhile, the even-numbered source lines, for example, S2 and S4 in FIG. 1, are in a floating state.

In the second half frame HF2, the odd-numbered source lines are in a floating state, and the data voltages V_S2n+2 of a positive potential or a negative potential are applied to the even-numbered source lines.

In a dot inversion method according to exemplary embodiment of the present invention, when the data voltage V_S2n+1 is applied to one of the odd-numbered source lines, the neighboring even-numbered source line enters a floating state. On the other hand, when the data voltages V_S2n+2 is applied to one of the even-numbered source lines, the neighboring odd-numbered source line enters a floating state.

The gate driving voltages according to the dot inversion method described in connection with FIG. 4A turn on the same cell transistor TFT once in each frame. The gate driving voltages according to the dot inversion method described in connection with FIG. 4B turn on the same cell transistor TFT twice in each frame. That is, the gate driving voltages according to the dot inversion method of FIG. 4B have to drive the gate lines twice as fast as the gate driving voltages according to the dot inversion method of FIG. 4A

FIG. 4C illustrates configurations of a screen according to the dot inversion method of FIG. 4B.

In the first half frame HF1 of the N frame the data voltages at a positive potential and a negative potential with respect to the common voltage Vcom are sequentially applied to the odd-numbered source lines S1 and S3, and the even-numbered source lines S2 and S4 are in a floating state (denoted by “•”). In the second half frame HF2 the odd-numbered source lines S1 and S3 are in a floating state, and the data voltages at a negative potential and a positive potential with respect to the common voltage Vcom are sequentially applied to the even-numbered source lines S2 and S4. When all the first and second half frames HF1 and HF2 in the N frame are combined, the data voltage at a positive potential and the data voltage at a negative potential are applied to the odd-numbered source lines S1 and S3 sequentially, and the data voltage at a negative potential and the data voltage at a positive potential are applied to the even-numbered source lines S2 and S4 sequentially. The potential of the data voltages is determined based on the common voltage Vcom.

In a similar fashion, the data voltages may be applied to the source lines in an N+1 frame, an N+2 frame, and an N+3 frame. A dot inversion method according to an exemplary embodiment of the present invention described in connection with FIG. 4C is applied to the N frame through the N+3 frame.

FIG. 5A is a timing diagram for illustrating a dot inversion method according to an exemplary embodiment of the present invention. Referring to FIG. 5A, one frame may be divided into gate line regions GT1, GT2, GT3, and GT4, and each gate line region GT1, GT2, GT3, and GT4 may be divided into a first section GO and a second section GE.

The common voltage Vcom is toggled from a first reference voltage V1 to a second reference voltage V2, or vice versa, at every boundary between the first sections GO and the second sections GE. The common voltage Vcom is also toggled from the first reference voltage V1 to the second reference voltage V2, or vice versa, every time the frame is changed, for example, when the N frame is shifted to the N+1 frame. In an exemplary embodiment of the present invention, the common voltage Vcom is not toggled when the gate line region is changed, for example, when the gate line region GT1 is shifted to the gate line region GT2, the gate line region GT2 is shifted to the gate line region GT3, or the gate line region GT3 is shifted to the gate line region GT4.

In the first section GO the data voltages V_S2n+1, which are at a positive potential or a negative potential with respect to the common voltage Vcom, are applied to the odd-numbered source lines. Meanwhile, the even-numbered source lines enter a floating state.

In the second section GE the odd-numbered source lines enter a floating state, and the data voltages V_S2n+2, which are at a negative or a positive potential with respect to the common voltage Vcom, are applied to the even-numbered source lines.

In a dot inversion method according to an exemplary embodiment of the present invention, when the data voltage V_S2n+1 is applied to one of the odd-numbered source lines, the neighboring even-numbered source line enters a floating state. On the other hand, when the data voltage V_S2n+2 is applied to the one of the even-numbered source lines, the neighboring odd-numbered source line enters a floating state.

The gate driving voltages according to the dot inversion described in connection with FIG. 4B turn on the same cell transistor TFT twice in each frame. The gate driving voltages according to the dot inversion method described in connection with FIG. 5A turn on the same cell transistor TFT once in each frame. That is, the gate driving voltages according to the dot inversion method of FIG. 4B are required to drive the gate lines twice as fast as the gate driving voltages according to the dot inversion method of FIG. 4A, whereas the gate driving voltages according to the dot inversion method of FIG. 5A are not needed to drive the gate lines at such speed.

FIG. 5B illustrates configurations of a screen according to the dot inversion method of FIG. 5A.

In the first sections GO of the N frame, the data voltages, which are at a positive potential and a negative potential with respect to the common voltage Vcom, are sequentially applied to the odd-numbered source lines S1 and S3, and the even-numbered source lines S2 and S4 enter a floating state (denoted by “•”). In the second sections GE of the N frame, the odd-numbered source lines S1 and S3 enter a floating state, and the data voltages, which are at a negative potential and a positive potential with respect to the common voltage Vcom, are sequentially applied to the even-numbered source lines S2 and S4. When the first sections GO and the second sections GE of the N frame are combined, the data voltages, which are at a positive potential and a negative potential, are applied to the odd-numbered source lines S1 and S3 sequentially, and the data voltages, which are at a negative potential and a positive potential, are applied to the even-numbered source lines S2 and S4 sequentially.

In a similar manner, the data voltages may be applied to the N+1 frame, the N+2 frame, and the N+3 frame. A dot inversion method according to an exemplary embodiment of the present invention described in connection with FIG. 5B is applied to the N through N+3 frame.

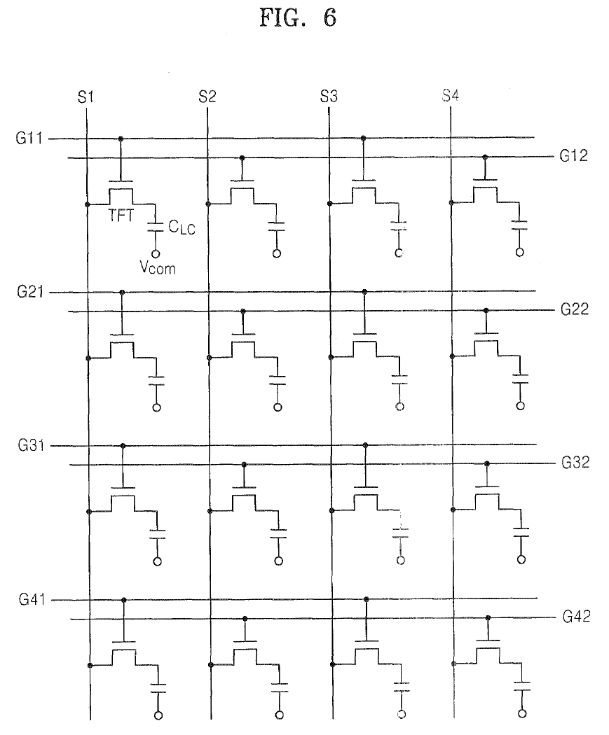

FIG. 6 is a circuit diagram of a display panel driven according to the driving method of FIG. 3C, FIG. 4B, or FIG. 5A.

FIG. 6 illustrates a plurality of source lines S1 through S4, cell capacitors CLCs, each of which includes a pixel electrode and a common electrode, cell transistors TFTs which transmit or block the data voltages applied to the source lines to the pixel electrodes, first gate lines G11, G21, G31, and G41 which control the turning on and turning off of the cell transistors TFTs connected to odd-numbered source lines S1 and S3, and second gate lines G12, G22, G32, and G42 which control the turning on and turning off of the cell transistors TFTs connected to even-numbered source lines S2 and S4.

In the display panel of FIG. 6, when the odd-numbered source lines S1 and S3 enter a floating state, the cell transistors connected to the first gate lines G11, G21, G31, and G41 are turned off. Meanwhile, when the even-numbered source lines S2 and S4 enter a floating state, the cell transistors connected to the second gate lines G12, G22, G32, and G42 are turned off. When a source line enters a floating state, the cell transistor connected to the source line in a floating state is turned off, and noise included in the source lines may be prevented from affecting the pixel electrodes of the cell capacitors CLCs.

In the display panel of FIG. 6, the turning on and turning off of the cell transistors TFTs electrically connected to the first gate lines G11, G21, G31, and G41 and the cell transistors TFTs electrically connected to the second gate lines G12, G22, G32, and G42 are controlled, and changes in the data voltages of the pixel electrodes due to parasitic capacitance components around the cell capacitors CLCs can be reduced.

The driving method illustrated in FIG. 3C, 4B, or 5A may be applied to the display panel illustrated in FIG. 6, and may be applied to the display panel illustrated in FIG. 1. Compared with the conventional display panel illustrated in FIG. 1, the display panel according to an exemplary embodiment of the present invention described in connection with FIG. 6 may reduce the effects generated by the floating state of the source lines.

When the display panel illustrated FIG. 1 or 6 is driven according to a driving method described in connection with FIG. 3C, 4B, or 5A, two source lines can be operated by one source amplifier. When driving two neighboring source lines, such as an odd-numbered source line and an even-numbered source line, the source amplifier applies the data voltage to the odd-numbered source line, and the even-numbered source line enters a floating state. On the other hand, when the source amplifier applies the data voltage to the even-numbered source line, the odd-numbered source line enters a floating state.

In an exemplary embodiment of the present invention one source amplifier can drive the two neighboring source lines, when a display panel including M source lines is driven, only M/2 source amplifiers are required, and the chip size required to implement the source amplifiers can be reduced.

In an exemplary embodiment of the present invention, a column inversion method or a dot inversion method is employed using a floating state of source lines, and the current consumption required to drive a display panel can be reduced.

In an exemplary embodiment of the present invention, one source amplifier can drive two neighboring source lines, and the chip size required to implement the source amplifiers can be reduced.

Although exemplary embodiments of the present invention have been described in detail with reference to the accompanying drawings for the purpose of illustration, it is to be understood that the inventive processes and apparatus should not be construed as limited thereby. It will be apparent to those of ordinary skill in the art that various modifications to the foregoing exemplary embodiments may be made without departing from the scope of the invention as defined by the appended claims, with equivalents of the claims to be included therein.

What is claimed is:

1. A method of driving a display panel that comprises a plurality of source lines, a plurality of gate lines, a plurality of cell capacitors each of which includes a pixel electrode and a common electrode, and a plurality of cell transistors each of which transmits a data voltage applied to the source line to the pixel electrode in response to a gate driving voltage applied to the gate line, the method comprising:
applying a common voltage to the common electrode, wherein the common voltage is toggled from a first reference voltage to a second reference voltage, or vice versa, at each boundary between a first half frame and a second half frame;
applying the data voltage at a positive or a negative potential with respect to the common voltage to odd-numbered source lines and operating even-numbered source lines to enter a floating state in the first half frame; and
applying the data voltage at a negative or a positive potential with respect to the common voltage to the even-numbered source lines and operating the odd-numbered source lines to enter a floating state in the second half frame.

2. The method of claim 1, wherein the method is a column inversion method.

3. The method of claim 1, wherein the gate driving voltage turns on a same transistor twice in each frame.

4. The method of claim 1, wherein the common voltage is not toggled from the first reference voltage to the second reference voltage, or vice versa, when the frame is changed.

5. The method of claim 4, wherein the first reference voltage is at a logic high level and wherein the second reference voltage is at a logic low level.

6. The method of claim 5, wherein in a first half frame of an N frame a potential of the common voltage is substantially equal to a potential of the second reference voltage, the data voltage at a positive potential with respect to the common voltage is applied to the odd-numbered source lines, and the even-numbered source lines enter a floating state.

7. The method of claim 6, wherein in a second half frame of the N frame, a potential of the common voltage is the same as the potential of the first reference voltage, the odd-numbered source lines enter a floating state, and the data voltages at a negative potential with respect to the common voltage are applied to the even-numbered source lines.

8. The method of claim 7, wherein in a first half frame of an N+1 frame, a potential of the common voltage is substantially equal to a potential of the first reference voltage, the data voltage at a negative potential with respect to the common voltage is applied to the odd-numbered source lines, and the even-numbered source lines enter a floating state.

9. The method of claim 8, wherein in a second half frame of the N+1 frame, a potential of the common voltage is substantially equal to a potential of the second reference voltage, the odd-numbered source lines enter a floating state, and the data voltage at a positive potential with respect to the common voltage is applied to the even-numbered source lines.

10. A method of driving a display panel that comprises a plurality of source lines, a plurality of gate lines, a plurality of cell capacitors each of which includes a pixel electrode and a common electrode, and a plurality of cell transistors each of which transmits a data voltage applied to the source line to the pixel electrode in response to a gate driving voltage applied to the gate line, the method comprising:
when a half frame is divided into gate line regions, applying a common voltage to the common electrode, wherein the common voltage is toggled from a first reference voltage to a second reference voltage, or vice versa, every time a gate line region is changed to the next gate line region;
in a first half frame, applying the data voltages at a positive or a negative potential with respect to the common voltage to odd-numbered source lines and operating even-numbered source lines to enter a floating state;
in a second half frame, operating the odd-numbered source lines to enter a floating state and applying the data voltages at a negative or a positive potential with respect to the common voltage to the even-numbered source lines.

11. The method of claim 10, wherein the method is a dot inversion driving method.

12. The method of claim 10, wherein the gate driving voltage turns on a same cell transistor twice in each frame.

13. The method of claim 10, wherein the common voltage is not toggled from the first reference voltage to the second reference voltage, or vice versa, when the half frame is changed from the first half frame to the second half frame.

14. The method of claim 13, wherein the common voltage is toggled from the first reference voltage to the second reference voltage, or vice versa, when the frame is changed to a next frame.

15. A method of driving a display panel that comprises a plurality of source lines, a plurality of gate lines, a plurality of cell capacitors each of which includes a pixel electrode and a common electrode, and a plurality of cell transistors each of which transmits a data voltage applied to the source line to the pixel electrode in response to a gate driving voltage applied to the gate line, the method comprising:
when a frame is divided into gate line regions and each gate line region is divided into a first section and a second section, applying a common voltage to the common electrode, wherein the common voltage is toggled from a first reference voltage to a second reference voltage, or vice versa, at every boundary between the first section and the second section;
in the first section, applying the data voltage at a positive or a negative potential with respect to the common voltage to odd-numbered source lines and operating even-numbered source lines to enter a floating state; and
in the second section, operating the odd-numbered source lines to enter a floating state and applying the data voltage at a negative or a positive potential with respect to the common voltage to the even-numbered source lines.

16. The method of claim 15, wherein the method is a dot inversion driving method.

17. The method of claim 15, wherein the gate driving voltage turns on a same cell transistor once in each frame.

18. The method of claim 15, wherein the common voltage is not toggled from the first reference voltage to the second reference voltage, or vice versa when the gate line region is changed to the next gate line region in a frame.

19. The method of claim 18, wherein the common voltage is toggled from the first reference voltage to the second reference voltage, or vice versa, when the frame is changed to a next frame.

20. A display panel comprising:
a plurality of source lines;
a plurality of cell capacitors each of which includes a pixel electrode and a common electrode;
a plurality of cell transistors each of which transmits or data voltage applied to the source line to the pixel electrode;
first gate lines to which gate driving voltages are applied, the gate driving voltages turning on and turning off the cell transistors connected to odd-numbered source lines; and
second gate lines to which gate driving voltages are applied, the gate driving voltages turning on and turning off the cell transistors connected to even-numbered source lines,
wherein the display panel is driven using a column inversion or dot inversion driving method.

21. The display panel of claim 20, wherein when the odd-numbered source lines enter a floating state, the cell transistors connected to the first gate lines are turned off.

22. The display panel of claim 20, wherein when the even-numbered source lines enter a floating state, the cell transistors connected to the second gate lines are turned off.

23. The display panel of claim 20, wherein when the display panel includes M source lines, the data voltages are applied to the M source lines by M/2 source amplifiers, where M is a natural number.

24. The display panel of claim 23, wherein each of the M/2 source amplifiers drives an odd-numbered source line and a neighboring even-numbered source line.

25. The display panel of claim 24, wherein each of the M/2 source amplifiers operates the neighboring even-numbered source line to enter a floating state when the data voltage is applied to the odd-numbered source line, and operates the odd-numbered source line to enter a floating state when the data voltage is applied to the neighboring even-numbered source line.

26. The display panel of claim 20, wherein the display panel is a liquid crystal display panel.
